(19) United States
(12) Patent Application Publication
(10) Pub. No.: US 2003/0014555 A1
(43) Pub. Date: Jan. 16, 2003

(54) System and method for efficient dispatch of interface calls

(76) Inventor: Michal Cierniak, San Jose, CA (US)

Correspondence Address: KENYON & KENYON (SAN JOSE), 333 WEST SAN CARLOS ST., SUITE 600, SAN JOSE, CA, 95110, US

(21) Appl. No.: 09/896,206

(22) Filed: Jun. 29, 2001

(51) Int. Cl. G06F 9/46; G06F 9/44

(52) U.S. Cl. 709/315

(57) ABSTRACT

A system includes an interface and a class configured to implement the interface. The system includes a function, the function a member of the class and a member of the interface. The system include an interface vtable, the interface vtable including a first pointer, the first pointer configured to point to the function. The system includes an object, the object an instance of the class. The object includes a second pointer, the second pointer configured to point to the interface vtable.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Computing environments for “object-oriented” programming are widespread. In an object-oriented computing environment, a grouping of data may be referred to as an “object”. User programs may specify a particular object using a “reference” to the object. References may be provided using pointers, or with other more abstract implementations.

The data in an object may be of different types. A structure that combines or organizes multiple pieces of data into an object may be referred to as a “class”. Multiple objects may be defined by a single class; each such object may be referred to as an “instance” of the class. A “subclass” may “inherit” the properties of its parent or superclass. A subclass generally may contain all the data elements found in its superclass, and may contain additional data elements.

A class may also include functions which may be used to provide access to data in objects that are instances of the class. Such functions may be referred to as “member functions” or “methods” of a class. A member function of a class may be defined in the class definition, which may provide a declaration that specifies how the function is invoked. An implementation for the member function may also be provided as part of the class definition, e.g., by providing a code for the function. However, an implementation need not always be provided in the class where a function is defined. For example, a subclass may inherit the implementations of functions given in a superclass, or may define alternative implementations of these functions. A “virtual” function is a function that is dispatched to the right implementation based on the type of the object. In many cases, the type of the object may not be known until runtime, which may require the use of a lookup mechanism, in order to locate the correct function implementation.

A class may define a function without implementing it, leaving the implementation to be provided in a subclass. A function which is only declared, but not implemented in the class, and whose implementation is not determined until the function is executed may be referred to as a “pure virtual” or “abstract” function or method. For example, a programmer may use a pure virtual function, having no implementation, where the concept that is to be implemented is known, but how to implement the function is not yet known. An implementation for a virtual function may be provided as part of a subclass.

An “interface” is a programming language structure that allows access to the data in a class to be abstracted. An interface defines a set of member functions which may be implemented by one or more classes. However, the member functions defined in an interface may be all virtual; the interface need not provide any implementation of the functions. A class may “implement” the interface by providing implementations for the functions defined by the interface. It will be appreciated that the same function may be “defined” both as a member of the interface and as a member of the class that implements the interface.

Programming languages such as Java and C# and platforms supporting multiple languages like CLI provide a type hierarchy with a single inheritance. Single inheritance means that a class inherits from only a single superclass. See J. Gosling, B. Joy, G. Steele, G. Bracha, THE JAVA LANGUAGE SPECIFICATION, Addison-Wesley, 1999; T. Lindholm and F. Yellin, THE JAVA VIRTUAL MACHINE SPECIFICATION, Second Edition, Addison-Wesley, 1999; European Computer Manufacturers Association (ECMA), C#Language Specification, Draft 01, October 2000; European Computer Manufacturers Association (ECMA), Common Language Infrastructure, Draft 02, January 2001. However, even though they only inherit from a single superclass, classes in these languages may implement multiple “interfaces”, i.e., a single class may provide implementations for several different defined interfaces.

A programming language or computing environment may provide an instruction to convert or “cast” a reference of one type to another type, e.g., a reference of a type defined by a class may be cast into a reference of a type defined by an interface that is implemented by the class. Casting is typically accomplished by use of a cast operator.

Implied type casting may also occur when a function is invoked, e.g., when invoking a member function of an interface with a reference as an argument, where the object referenced by the reference is an instance of the class that implements the interface.

A programming language or computing environment may provide procedures for invoking a member function for a referenced object that has been cast as an interface type. These procedures, which may be referred to as “interface function dispatch” or “interface method dispatch”, are conventionally accomplished with special procedures that may be more expensive than a regular function call.

### BRIEF DESCRIPTION OF THE DRAWINGS

FIG. 1 illustrates an example program that includes a virtual member function of a class, and code which triggers the dispatch of this virtual member function.

FIG. 2 illustrates example data structures that may be used in providing function dispatch for the code previously illustrated in FIG. 1.

FIG. 3 illustrates an example code including interfaces that have virtual member functions.

FIG. 3B illustrates an example code whose execution may result in the dispatch of an interface member function.

FIG. 4 illustrates an example internal data structure that enables the dispatch of functions for the data structures defined in FIGS. 3 and 3B.

FIG. 5 illustrates an example procedure for dispatching a virtual member function of an interface, according to an example embodiment of the present invention.

FIG. 6 illustrates an example procedure for resolving the casting of a reference to an object from an interface type to the type of a class that implements the interface, according to an example embodiment of the present invention.

FIG. 7a illustrates an example data structure which may be used to provide dispatch of interface member functions, according to an example embodiment of the present invention.

FIG. 7b illustrates a second example data structure which may be used to provide dispatch of interface member functions, according to an example embodiment of the present invention.

### DETAILED DESCRIPTION OF THE EXAMPLE EMBODIMENT

Conventional Function Dispatch with Vtables

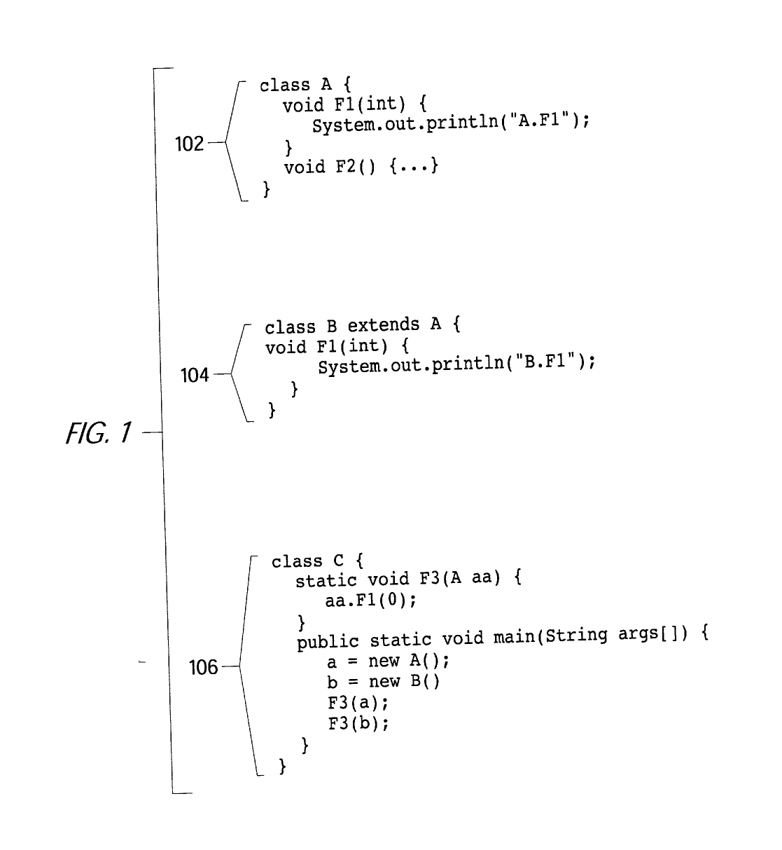

FIG. 1 illustrates an example program that includes a virtual member function of a class, and code which triggers the dispatch of this virtual member function. Although the example program is written in the Java™ language for illustration, it will be appreciated that other object-oriented languages could be used. Code fragment 102 includes the definition of a class A. Class A has two member functions F1 and F2. Both F1 and F2 are defined in class A and implemented in class A. Function F2's implementation is not shown, but is merely represented by ellipses.

In FIG. 1, code fragment 104 includes a definition of a class B. Class B is a subclass of A; Class B extends class A. Class B has a definition and implementation for member function F1 that replaces the definition of member function F1 in class A for objects that are instances of class B. Class B inherits the definition and implementation of function F2 from class A.

In FIG. 1, code fragment 106 includes a definition of class C. Class C includes a definition and implementation for a member function F3. Function F3 receives a reference to an object as an argument and returns the value of function F1. However, it will be appreciated that function F3 may invoke different implementations of function F1 depending on whether the argument to function F3 is a reference to an object of class A or class B (a subclass of A). For example, in the portion of the code fragment 106 that forms the main function of class C, Function F3 is invoked twice, once with an argument a, a reference to an object of class A, and once with an argument b, a reference to an object of class B. When the function F3 is invoked, the correct implementation of function F1 to execute may need to be determined.

The procedure used to locate the correct implementation to execute when a function is invoked may be termed “dispatch” of the member function. An internal data structure called a “vtable” may be used as part of the dispatch procedure. It will be appreciated that different objects that are instances of the same class may share a common vtable. Every object may include field at a known offset (in many implementations that offset is set to 0) with a pointer to the vtable for the class the object instances. The vtable may contain an array of function pointers to implementations of the virtual member functions of the class. The call sequence for a function may include loading the vtable pointer into a register, adding an offset to index into the function pointers array, loading the pointer, and performing an indirect call. The compiler may generate a table at compile time that indicates the correct index for each function name to be determined.

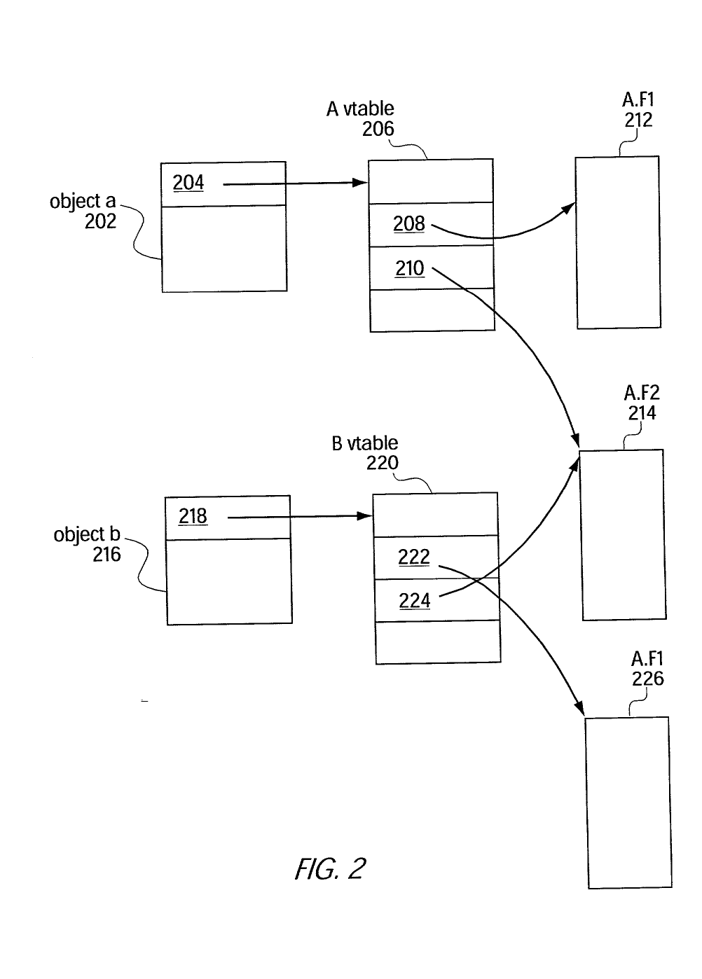

FIG. 2 illustrates example data structures that may be used in providing function dispatch for the code previously illustrated in FIG. 1. In FIG. 2, object a 202, an instance of class A, may include a pointer 204 to the class A vtable 206. The class A vtable 206 may contain pointers to implementations of functions defined in class A. The class A vtable 206 may include pointers 208 and 210, pointer 208 referring to function A.F1 212 and pointer 210 to function A.F2 214. Both A.F1 212 and A.F2 214 are member functions of class A. It will be appreciated that if objects of class A included other functions, additional pointers may be provided in the class A vtable 206.

Similarly, object b 216 is an instance of class B. Class B is a subclass of class A. Object b 216 may include a pointer 218 to the class B vtable 220. The class B vtable 220 may include a pointer 222 to a function B.F1 226. It will be appreciated that objects of class B may use a different code for function F1 than objects of class A. The B vtable 220 may also include a pointer 224 to function A.F2 214, i.e., the subclass B may inherit A.F2 from superclass A, thus using the same code to provide function F2 as superclass A.

Illustrated below is an example assembly code that may be generated for the dispatch of function F3 in the example JAVA program illustrated in FIG. 1 using standard vtable mechanism of FIG. 2. For illustration, the example is written in the assembly language for the Intel® IA-32 processor architecture, but it will be appreciated that assembly languages for other processors could be used.

| | |
|---|---|
| push eax | // push the pointer |
| push 0 | // push the argument |
| mov eax, [eax] | // load the vtable |
| call [eax + 24] | // perform the indirect call |

The example code assumes that the pointer to an object of class A is contained in register eax. The example code assumes the address of the pointer to the class A vtable is at offset 0 in the object. It will be appreciated that the address of the pointer may be stored in some other pre-defined location. The example code also assumes that the offset for the F1 entry in the class A vtable 206 is 24, and that offset in the B vtable 220 is identical. If the offsets are not identical, it will be appreciated that steps must be taken to determine the offsets. An example procedure including steps for determining the offsets in code that includes interfaces is described in more detail below.

Conventional Function Dispatch With Interfaces

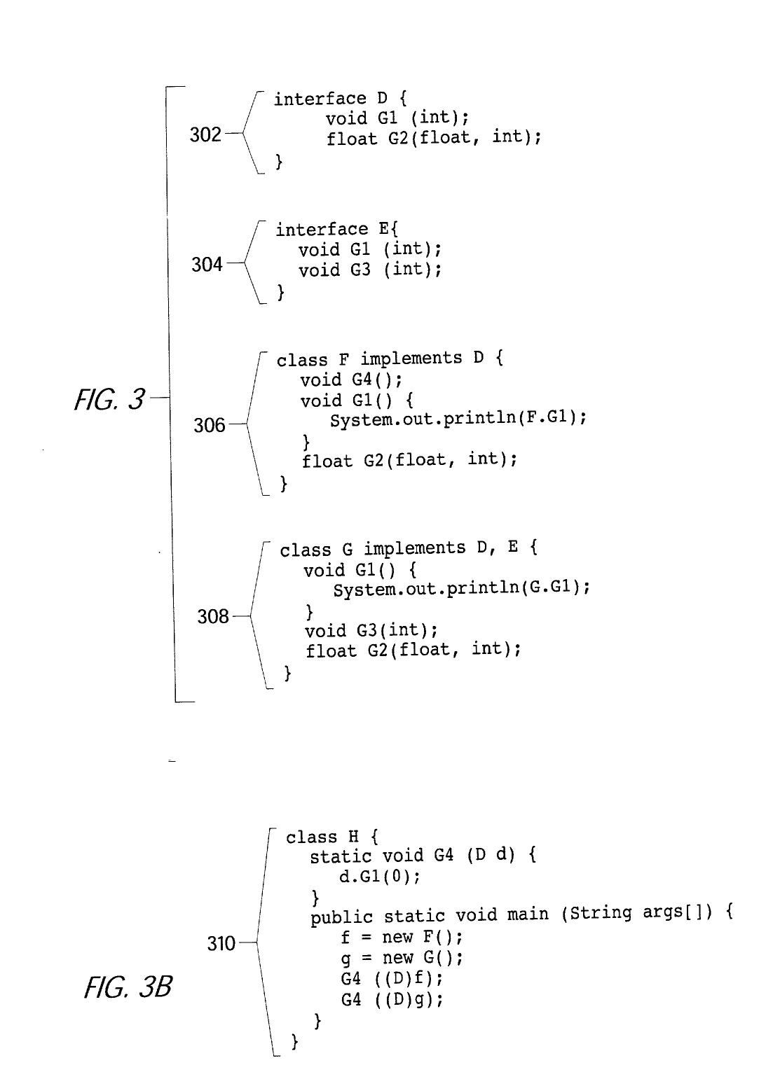

FIG. 3 illustrates an example code including interfaces that have virtual member functions. The code fragment marked 302 defines an interface D. Interface D may include two virtual member functions, G1 and G2. The code fragment marked 304 defines an interface E. Interface E may include two virtual member functions, G1 and G3. The code marked 306 defines a class F that implements the interface D. The class F contains three member functions, G4, G1, and G2. The code marked 308 defines a class G that implements the interface D and the interface E. The class G includes three member functions G1, G3, and G2.

FIG. 3B illustrates an example code whose execution may result in the dispatch of an interface member function. The class H defined in code fragment 310 includes a member function G4 whose argument is of type D, the interface defined in code fragment 302 above. The main portion of class H includes one object f, of class F, and one object g, of class G. The function G4 ((D)f) has an argument of type D as implemented by class F. The function G4 ((D)g) has an argument of type D as implemented by class G.

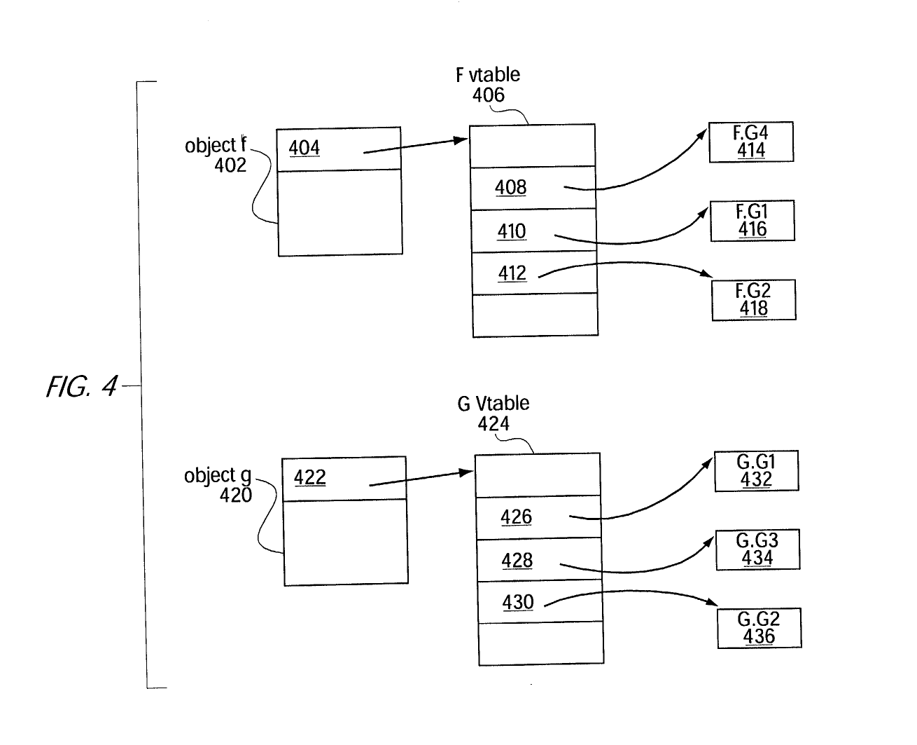

FIG. 4 illustrates an example internal data structure that enables the dispatch of functions for the data structures defined in FIGS. 3 and 3B. An object f 402 of class F includes a pointer 404 to the class F vtable 406. The F vtable 406 includes a pointers 408, 410, and 412. Pointer 408 may refer to function F.G4 414. Pointer 410 of class F may refer to function F.G1 416. Pointer 412 may refer to function F.G2 418.

The data structures illustrated in FIG. 4 may also include an object g 422 of class G. Object g includes a pointer 422 to the class G vtable 424. The class G vtable 424 includes pointers 426, 428, and 430. Pointer 426 may refer to function G.G1 432. Pointer 428 may refer to function G.G3 434. Pointer 430 may refer to function G.G2 436. It will be appreciated that, because the classes F and G defined the functions they contain in a different order, the functions in the F vtable and G vtable are at different locations. For example, F.G1 is shown as the second function in the F vtable, while G.G1 is the first function shown in the G vtable.

In a conventional implementation, the dispatch of interface member function H.G4 from FIG. 3B may have a non-constant instruction sequence. Different invocations of H.G4 may use different implementations and pointers to these different implementations are found at different locations depending on the type of the object that is used as the argument when H.G4 is invoked. This can be illustrated by looking at the vtables of classes F and G shown in FIG. 4. Both classes F and G implement the same interface D, but because the member functions G1 and G2 implementing D were defined in different order in classes F and G, the pointers to the member functions G1 and G2 have different offsets in the vtables of classes F and G. Thus, the offset into the vtable may be unknown at compile time (because it depends on the actual type of the object and is different for objects f and g). Therefore extra instructions may need to be executed as part of the interface dispatch to determine the actual offset or to access an additional data structure with a constant offset.

A conventional example assembly language code implementing interface member function dispatch for H.G4 may be

push function_id

push eax

call get_function_pointer

call [eax]

The first line of this assembly code fragment saves an function identifier on the stack. The second line saves the contents of register eax on the stack. This assembly code assumes that the pointer to object a is in register eax. The assembly code also assumes function get_function_pointer provides a mechanism for locating the pointers to particular functions in the vtable of a class. The function get_function_pointer may search the vtable of a class to find the position that a given member function has in the vtable for that class, e.g., by comparing the function identifier to an index field in the class vtable that has function identifiers. The function get_function_pointer may store the location of the pointer to the function in register eax. The fourth line of the assembly code fragment invokes the correct function implementation by executing a call instruction to the address contained in the register eax.

Alternatively, as in the Intel® Open Runtime Platform (ORP), class vtables may contain an array or list of pointers, one for each interface implemented by the class. Each pointer points to an interface description for an interface implemented by the class, which may be stored as a list attached to the class vtable. The interface description may contain a table, list, or array of pointers to the implementations of the member functions of the interface. Dispatching a member function of an interface may be accomplished by searching the interface descriptions attached to a class vtable to find the correct one, and then returning a pointer to the correct interface vtable. The appropriate entry in the interface vtable may then be used to invoke the function.

It will be appreciated that, because the conventional methods for dispatching the function may require searching and multiple levels of indirect referencing, this may slow the dispatch of interface functions.

### EXAMPLE EMBODIMENT

In an example embodiment of the present invention, the internal data structure of objects which are instances of a class that implements interfaces may be modified to include extra fields. These additional fields may include pointers to interface vtables for the interfaces implemented by the class. These pointers may allow the more efficient dispatch of interface functions. Additional pointers added to the internal data structure of the objects which are instances of a class that implements interfaces may allow the efficient casting of references of an interface type into references whose type is defined by the class that implements the interface.

### Example Function Dispatch Procedure

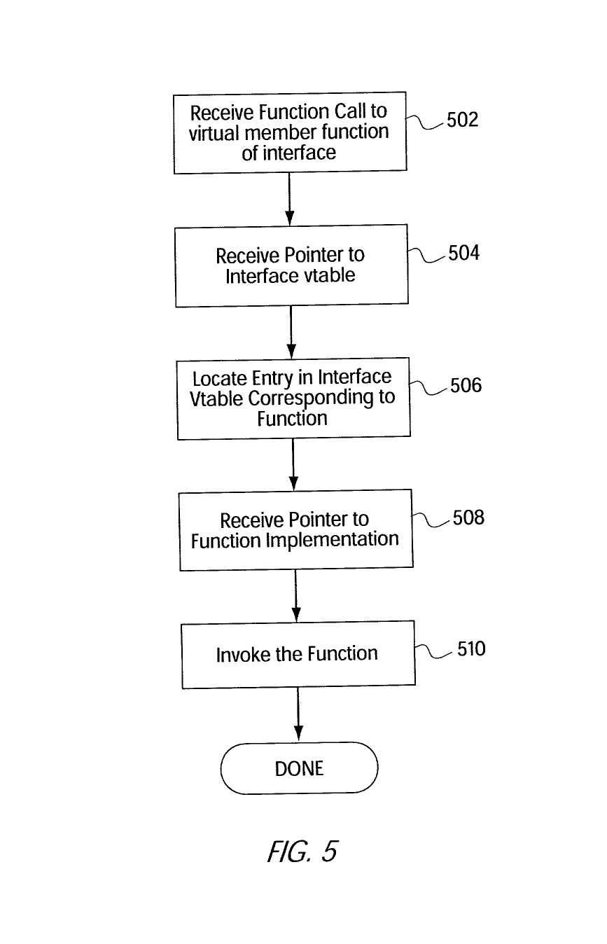

FIG. 5 illustrates an example procedure for dispatching a virtual member function of an interface, according to an example embodiment of the present invention. In step 502 a function call to a function which is a virtual member of the interface is received, e.g., by the run-time system or virtual machine. The argument of a virtual member function may be a reference to an object of a particular type that implements the interface. As discussed previously, references may be implemented as pointers, or with a more abstract structure. It will be appreciated that, in the example embodiment, an object may have the same internal data structure whether the object is an instance of a class or an instance of an interface implemented by the class.

In step 504, a pointer to the interface vtable for the interface may be received, e.g., by reading it from the object referenced by the reference received in step 502 above. In the example embodiment, a pointer to the interface vtable may be included as an extra field at a predetermined location in each instance of a class that implements an interface. The pointer to the interface vtable may be located at a predetermined offset from the base address of an object of a class that implements the interface. The value of this offset may be known to the compiler, and used in compilation of the program. This predetermined location may be indicated in the class definition.

In step 506, an entry corresponding to the function that is being dispatched may be located in the interface vtable. The interface vtable may be indexed by function name, or entry may be stored at a predetermined offset from the base address of the interface vtable, or other conventional efficient mechanism for locating the correct entry may be used, e.g., a hash table.

In step 508, the entry in the interface vtable that corresponds to the function may be received and used (as a pointer) to locate the correct function implementation for the function being dispatched.

In step 510, the implementation of the function may be invoked, for example by using a call assembly instruction. For example, a call assembly instruction may be invoked with the address of the function implementation given by the entry in the interface vtable as the location to call. If the function expects an argument with the type of the class that implements the interface, the function may receive a pointer to the canonical base address of the referenced object. A pointer to the canonical base address may be located at a predetermined location, which may be known to the compiler, e.g., adjacent to the pointer to the interface vtable.

It will be appreciated that in the example procedure described above, multiple steps may be combined, e.g., locating the entry and receiving the pointer may be accomplished in a single instruction by using assembly language indirect addressing.

It will be appreciated that the example procedure described above could be provided as a set of instructions adapted to be executed by a processor. These instructions could be stored on a computer-readable medium, e.g., a disk, a tape, a flash memory, etc.

### Example Cast Resolution Procedure

In the example embodiment, extra fields may be added to the beginning of every object implementing an interface. References of an interface type to such an object may be implemented with a pointer to these extra fields. The extra fields may also include a pointer to the canonical base address of the object, i.e., the base address of the object without the additional fields added. These additional fields allows the efficient casting of an reference to an object from the interface type to the type of the class that implements the interface. An example procedure for this type casting is described below.

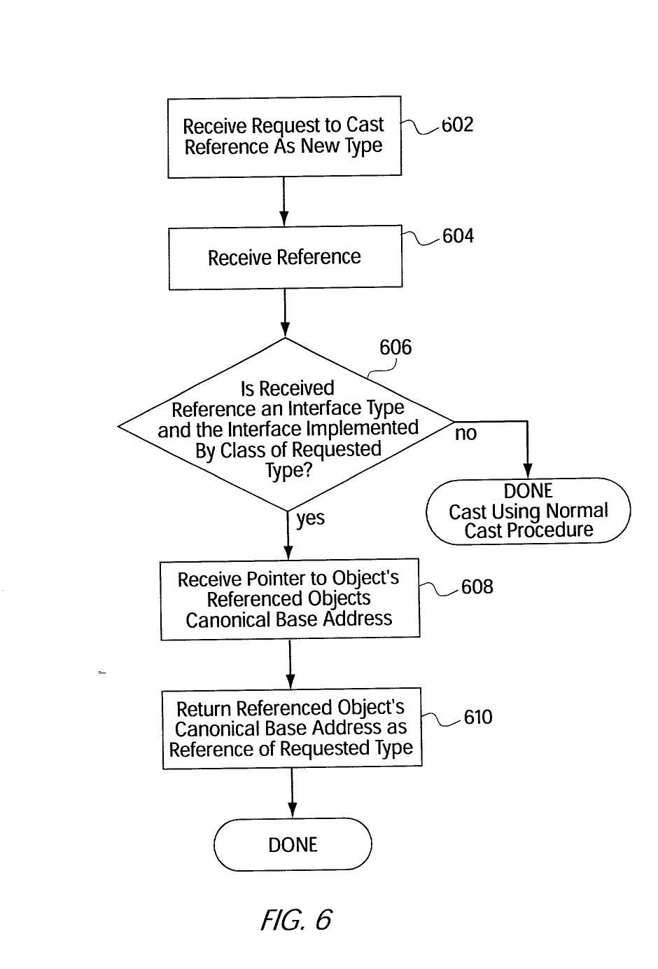

FIG. 6 illustrates an example procedure for resolving the casting of a reference to an object from an interface type to the type of a class that implements the interface, according to an example embodiment of the present invention. The example procedure may begin in step 602 with the receipt of a request to cast the reference into a new type. Such a request may be indicated by the use of a cast operator in Java, C, or other programming language, or by the explicit invocation of a “cast” function that receives a reference to an object of one type and returns a reference to an object of different type, or implicitly where a member function of the target class is invoked with a reference of interface type as an argument.

In step 604 the reference to be cast may be received. It will be appreciated that this reference to the object may be received simultaneously with the request to cast, e.g., as an argument to a function call, or as an implicit part of an interface member function dispatch. Depending on the implementation, the reference may be a pointer to an object.

In step 606, whether the reference is an interface type which is implemented by the class type that the reference is being cast into may be determined. If the reference is not of this type, the example procedure may be terminated, and a normal reference casting procedure may be used to complete the casting of the reference. If the reference is of this type, the example procedure may continue with step 608. It will be appreciated that step 606 may be optional. For example, in the application of the example casting procedure as part of interface function dispatch, it will be known that the reference is of interface type.

In step 608, the example procedure may receive a pointer to the object's canonical base address. This pointer may be located at a predetermined position in the object referred to by the reference, e.g., adjacent to a pointer to the interface vtable in the object's internal data structure.

In step 610, a reference of the appropriate type may be returned. This reference may be derived from the pointer received in step 608. For example, in a system where pointers are used as references without additional abstraction, the pointer to the canonical base address may be returned. If the example casting procedure is used as part of the example procedure for dispatching an interface member function, the pointer to the canonical base address may be passed as an argument to the member function.

### Example Data Structures for Interface Member Function Dispatch

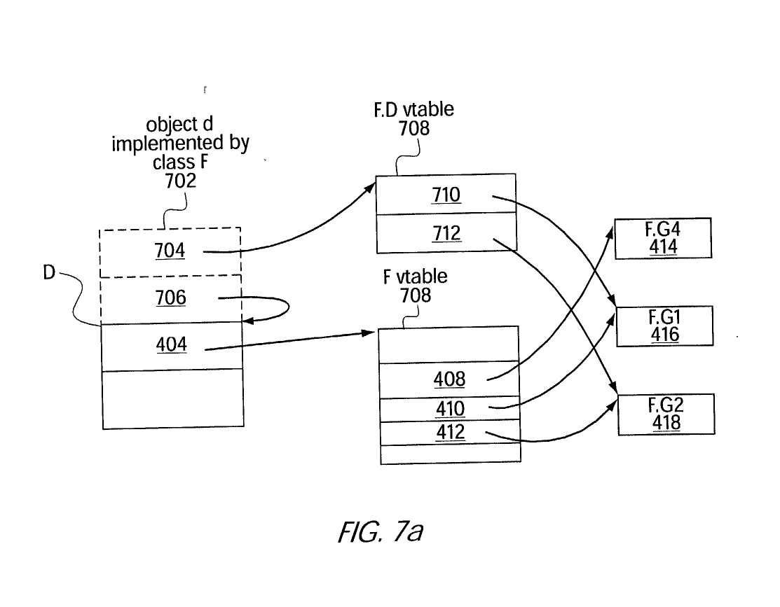

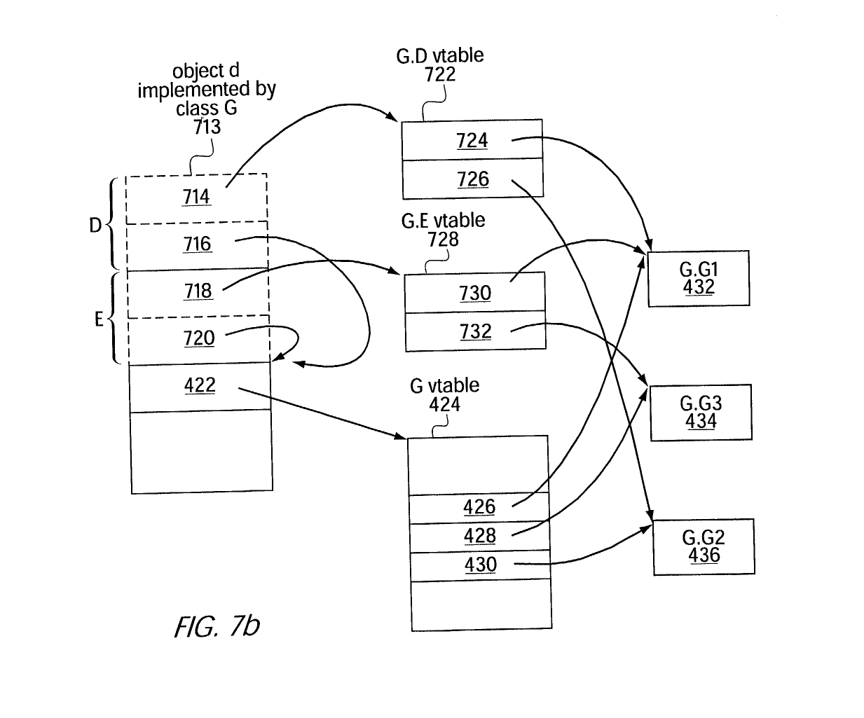

FIGS. 7a and 7b illustrate example data structures which may be used to provide dispatch of interface member functions, according to an example embodiment of the present invention. The illustrated example data structure provides data structures for the code fragment given in FIG. 3, and may enable efficient dispatch of interface member functions in the code illustrated in FIG. 3B. The data structures shown in FIG. 7a may be created by extending the conventional data structures previously illustrated in FIG. 4.

In FIG. 7a, object d 702 is an instance of interface D implemented by class F. Object d 702 contains an interface vtable pointer 704. Object d 702 also contains a canonical base address pointer 706. The pointer 706 may be configured to point to the canonical base address of object d 702.

The interface vtable pointer 704 may include a pointer to a vtable for the interface as implemented by a particular class, e.g., F.D vtable 708 is a vtable for interface D as implemented by class F. The interface vtable includes pointers 710 and 712, which may be pointers to functions provided by the class that implements the interface. In the illustration, function F.G1 416 is pointed to by F.D vtable 708 pointer 710, and function F.G2 418 is pointed to by F.D vtable 708 pointer 712.

The canonical base address pointer 706 may be configured to indicate the canonical base address of the object d. This canonical base address would be the base address of the object d, if the object were merely an object of class F, rather than an instance of interface D as implemented by class F. The rest of the object d, referenced by the canonical base address pointer 706, may be the same as a normal instance of an object of class F. For example, the first entry referenced by object's canonical base address pointer 706 may be a pointer 404 to the class F vtable 406, which may be the same as the class F vtable 406 previously illustrated in FIG. 4.

It will be appreciated that, as shown in the figure, a class may implement more than one interface. For example, object d of type D may also be implemented by class G, instead of by class F. An object d 713 of type D implemented by class G is illustrated in FIG. 7b. For example, class G, as illustrated in the FIG. 7b, implements both interface D and interface E. Depending on which interface the object is an instance of, the proper interface type may be obtained by referencing the object with a pointer to the vtable pointer of the appropriate class. The object d 713 of type D implemented by class G, may include two different interface vtable pointers, 714 and 718. Vtable pointer 714 is a pointer to the G.D vtable 722, for use when the object an instance of D. Vtable pointer 718 is a pointer to the G.E. vtable 728, for use when the object implemented by the class G an instance of E. The drafted portion of object d 713 indicates fields that may be added, e.g. to a conventional object g 420 as shown in FIG. 4, in order to form object d 713.

It will be appreciated that, although the interface vtable pointer and canonical base address pointer have been appended before the canonical base of the object, those fields may be placed at any predetermined location in the object. The interface vtable pointer and canonical base address pointer for a particular interface need not be placed adjacent to each other, e.g., all the interface vtable pointers might be placed together.

In the example embodiment, the same assembly instruction sequence may be used for interface virtual function dispatch as was previously described for ordinary function dispatch. As was described above, the example embodiment may add extra fields to every object implementing an interface, e.g., vtable pointer 704 and object base reference 706 described above. When an interface function is dispatched, the correct vtable may be directly accessed using a standard vtable dispatch sequence, for example:

| // Assume that the reference to the object is in register eax | |
|---|---|
| // Assume that the offset for the function entry in the interface | |
| // vtable is 8. | |
| push [eax + 4] | // push the pointer to the canonical base address |
| push 0 | // push the argument |
| mov eax, [eax] | // load the vtable |
| call [eax + 8] | // perform the indirect call |

In the example code illustrated, a reference to an object that is an instance of an interface is found is register eax. The reference to the interface vtable is found at a predetermined position, e.g., the base of the object which is an instance of the interface. For example, this reference could be implemented to memory location 704 in FIG. 7a above, for an interface D implemented by class F. The example code assumes the canonical base address of the object is found at a 4 byte offset from where the reference to the object points. Line 1 in the example assembly code fragment saves the canonical base address on the stack. Line 3 loads the interface vtable. This instruction assumes that the reference to the interface vtable is found at the address pointed to by the reference to the object. Line 4 invokes the correct implementation of the desired function. Line 4 assumes that there is an 8-byte offset in the interface vtable to the entry for the desired function. This information is known to the compiler, and no searching is required when the function is dispatched at run time.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A system comprising:
an interface;
a class, the class configured to implement the interface,
a function, the function a member of the class and a member of the interface;
an interface vtable, the interface vtable comprising a first pointer, the first pointer configured to point to the function; and
an object, the object an instance of the class, the object comprising a second pointer, the second pointer configured to point to the interface vtable.

2. The system according to claim 1, wherein
the object comprises a third pointer, the third pointer configured to point to a canonical base address for the object.

3. The system of claim 2, wherein
the third pointer is located at a predefined offset from the second pointer.

4. The system of claim 3, wherein
the third pointer is adjacent to the second pointer.

5. The system according to claim 1, further comprising:
a class vtable, the class vtable comprising a fourth pointer, the fourth pointer configured to point to the function.

6. The system of claim 5, wherein
the function has a name, and the class vtable is indexed by the name of the function.

7. The system of claim 1, wherein
the function has a name, and the interface vtable is indexed by the name of the function.

8. A method for function dispatch, comprising:
receiving a request to invoke a function, the function being a member of an interface, the function being a member of a class that implements the interface;
receiving a first pointer, the first pointer configured to point to an interface vtable, the interface vtable associated with the interface, an object comprising the first pointer, the object being an instance of the class that implements the interface;
receiving a second pointer, the second pointer configured to point to the function, the interface vtable comprising the second pointer; and
invoking the function.

9. The method of claim 8, wherein
the function is invoked with the canonical base address of the object as an argument.

10. An article of manufacture comprising a computer-readable medium having stored thereon instructions adapted to be executed by a processor, the instructions which, when executed, define a series of steps to be used to control a method for function dispatch, said steps comprising:
receiving a request to invoke a function, the function being a member of an interface, the function being a member of a class that implements the interface;
receiving a first pointer, the first pointer configured to point to an interface vtable, the interface vtable associated with the interface, an object comprising the first pointer, the object being an instance of the class that implements the interface;
receiving a second pointer, the second pointer configured to point to the function, the interface vtable comprising the second pointer; and
invoking the function.

11. The article of manufacture of claim 10, wherein
the function is invoked with the canonical base address of the object as an argument.

12. A method for casting a reference to an object, comprising:
receiving a first reference, the first reference configured to refer to an object, the first reference having a type defined by an interface;
receiving a request to cast the first reference to a type defined by a class that implements the interface; and
receiving a pointer, the pointer contained in the object, the pointer configured to point to a canonical base address of the object.

13. The method according to claim 12, wherein
the pointer is located at a predetermined offset from a memory location referenced by the first reference.

14. The method according to claim 12, further comprising:
returning a second reference, the second reference having a type defined by the class that implements the interface.

15. An article of manufacture comprising a computer-readable medium having stored thereon instructions adapted to be executed by a processor, the instruction which, when executed, define a series of steps to be used to control a method for casting a reference, said steps comprising:
receiving a first reference, the first reference configured to point to an object, the first reference having a type defined by an interface;
receiving a request to cast the first reference to a type defined by a class that implements the interface; and
receiving a pointer, the pointer contained in the object, the pointer configured to point to a canonical base address of the object.

16. The article of manufacture of claim 15, wherein
the pointer is located at a predetermined offset from the location referenced to by the first reference.
